(19) United States
(12) Patent Application Publication
(10) Pub. No.: US 2026/0266965 A1
(43) Pub. Date: Sep. 10, 2026

(54) LIDAR ANGLE LOCKING MECHANISM, LIDAR, AND VEHICLE

(71) Applicant: AUTOX TECH PTE. LTD., SINGAPORE (SG)

(72) Inventors: Zhuo Li, Shenzhen (CN); Yujian Zhong, Shenzhen (CN); Ming Chen, Shenzhen (CN); Cheng Liu, Shenzhen (CN); Jianqiang Zhang, Shenzhen (CN); Yizhou Shan, Shenzhen (CN)

(73) Assignee: AUTOX TECH PTE. LTD., SINGAPORE (SG)

(21) Appl. No.: 19/257,437

(22) Filed: Jul. 1, 2025

(30) Foreign Application Priority Data
Mar. 7, 2025 (CN) 2025102761274

(51) Int. Cl. G01S 7/481; G01S 17/931

(52) U.S. Cl. CPC G01S 7/4817; G01S 7/4813; G01S 17/931

(57) ABSTRACT

The disclosure provides A LiDAR angle locking mechanism, including: a stator assembly; a rotor assembly, coupled to the stator assembly by a rotating shaft, the rotor assembly including a window; and a motor, configured to drive the rotor assembly rotate with respective with the stator assembly around the rotating shaft; a bistable self-holding electromagnet; a controller, and a latching pin, arranged between the rotating shaft and the bistable self-holding electromagnet. The latching pin is capable of locking and unlocking the rotor assembly thorough the bistable self-holding electromagnet based on a forward voltage or a reverse voltage is received by the bistable self-holding.

This non-provisional patent application claims priority under 35 U.S. C. § 119 from Chinese Patent Application No. 202510276127.4 filed on Mar. 7, 2025, the entire content of which is incorporated herein by reference.

### TECHNICAL FIELD

The disclosure relates to the technical field of LiDAR, in particular to a LiDAR angle locking mechanism, a LiDAR, and a vehicle.

### BACKGROUND

In the prior art, a mechanical LiDAR usually includes two parts: a stator assembly and a rotor assembly. The rotor assembly can be inside or outside. The window of the optical system is located in the rotor assembly. For a mechanical LiDAR with the rotor assembly outside, in order to prevent the LiDAR window from being dirtied or scratched after the vehicle is turned off and to facilitate monitoring whether the window is damaged, the rotor assembly needs to be braked on a side facing a protected side of the window after power failure, such as a side facing the vehicle body for the LiDAR window around the vehicle body.

A brake for electronic equipment power failure is usually a friction brake. The friction brake utilizes a brake disc and an electromagnetic mode to achieve braking. When powered on, electromagnetic force isolates the stator and the rotor brake disc, allowing the rotor to rotate freely. When power is lost, the stator and the rotor brake disc contact under the action of a spring, thereby preventing the rotor from rotating and achieving braking. In order to ensure sufficient friction torque, the friction brake is usually large in size, and it is necessary to keep the power-on state during operation. The coil continuously generates heat, increasing the power consumption of the electronic equipment.

### SUMMARY

The disclosure provides a LiDAR angle locking mechanism, a LiDAR, and a vehicle.

In a first aspect, the disclosure provides a LiDAR angle locking mechanism, A LiDAR angle locking mechanism, including a stator assembly; a rotor assembly, coupled to the stator assembly by a rotating shaft, the rotor assembly including a window; and a motor, configured to drive the rotor assembly rotate with respective with the stator assembly around the rotating shaft; a bistable self-holding electromagnet; a controller, and a latching pin, arranged between the rotating shaft and the bistable self-holding electromagnet; wherein: when the LiDAR is powered off, the rotor assembly rotates to make the window face to a predetermined protected side; the controller provides a forward voltage to the bistable self-holding electromagnet so that the latching pin ejects and inserts into the rotor assembly to lock the rotor assembly, and the motor stops operating; when the LiDAR is powered on, the controller provides a reverse voltage to the bistable self-holding electromagnet so that the latching pin retracts and withdraws from the rotor assembly to unlock the rotor assembly; after the rotor assembly is unlocked, the motor starts to operate and drives the rotation of the rotor assembly.

In a second aspect, the disclosure provides a LiDAR, including a LiDAR transceiver device and the LiDAR angle locking mechanism described above.

In a third aspect, the disclosure provides a vehicle, wherein the vehicle includes a vehicle roof and the LiDAR arranged on the vehicle roof.

The LiDAR angle locking mechanism, the LiDAR, and the vehicle described above utilize an electromagnetic brake driving latching pin scheme to lock the window in the rotor assembly to a side facing a protected side when the LiDAR is powered off. This avoids dirt, damage, and detection of the LiDAR window. The locking scheme of the disclosure has a simple structure, is easy to integrate and miniaturize, and does not require long-term power supply when the LiDAR is operating or turned off. It only needs to be powered on instantly during startup or shutdown, which can reduce power consumption and heat generation. When subjected to a large rotation torque, the rotating shaft or the latching pin is not easily damaged.

### BRIEF DESCRIPTION OF THE DRAWINGS

In order to more clearly illustrate the technical solutions in the embodiments of the disclosure or in the prior art, the drawings to be used in the description of the embodiments or the prior art will be briefly introduced below. Obviously, the drawings described below are merely some embodiments of the disclosure.

For those of ordinary skill in the art, other drawings can be obtained based on the structures shown in these drawings without creative efforts.

FIG. 1 is a schematic diagram of a LiDAR angle locking mechanism in accordance with an embodiment.

FIG. 2 is an overall structural schematic diagram of a LiDAR angle locking mechanism in accordance with an embodiment.

FIG. 3 is a schematic diagram of a stationary state of a LiDAR in accordance with an embodiment.

FIG. 4 is a schematic diagram of a working state of a LiDAR in accordance with an embodiment.

FIG. 5 is a schematic diagram of a vehicle in accordance with an embodiment.

The realization of the objectives, functional features, and advantages of the disclosure will be further described below in combination with the embodiments with reference to the drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the disclosure and are not intended to limit the disclosure. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the disclosure are configured to distinguish similar planning objects and are not necessarily configured to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the disclosure are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the disclosure.

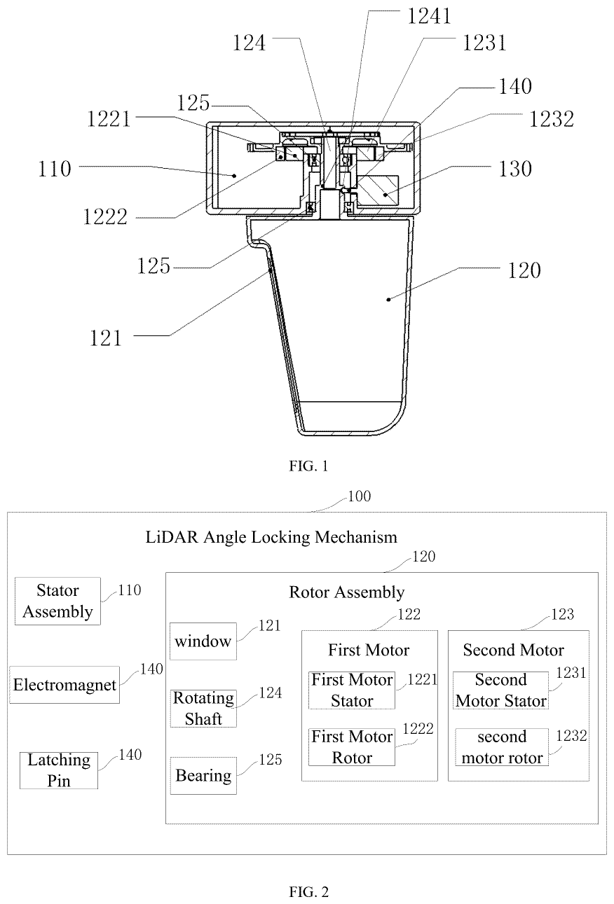

Referring to FIGS. 1 to 2, FIG. 1 is a schematic diagram of a LiDAR angle locking mechanism in accordance with an embodiment. FIG. 2 is an overall structural schematic diagram of a LiDAR angle locking mechanism in accordance with an embodiment. The LiDAR angle locking mechanism 100 is applied to the LiDAR 200 to locking the the LiDAR 200 in a desired angle. The LiDAR angle locking mechanism 100 includes a stator assembly 110, a rotor assembly 120, a bistable self-holding electromagnet 130, a controller (not shown), and a latching pin 140.

The stator assembly 110 is substantially cylindrical. The stator assembly 110 is a support component in the LiDAR angle locking mechanism 100, configured to support the rotor assembly 120 and rotatably connected to the rotor assembly 120. The stator assembly 110 also carries the bistable self-holding electromagnet 130 and the latching pin 140.

The rotor assembly 120 is substantially a truncated irregular cone, and connected to the stator assembly 110. The rotor assembly 120 includes a window 121, a first motor 122, a second motor 123, and a rotating shaft 124. The first motor 122 and the second motor 123 are opposite to each other on two sides of the rotating shaft 124. A bearing 125 is also arranged beside the rotating shaft 124, and the bearings 125 are symmetrically arranged on two sides of the rotating shaft 124.

The window 121 is positioned on an outer surface of the rotor assembly 120 and rotates synchronously with the rotor assembly 120. The window 121 is configured to penetrate the emitted laser beam and the returned echo beam of the emitted beam, and the window 121 can also filter out some stray light.

The first motor 122 is located in the stator assembly 110 and is configured to drive the rotation of the rotor assembly 120. The first motor 122 includes a first motor stator 1221 and a first motor rotor 1222. The first motor stator 1221 is arranged on a side close to the rotating shaft 124 and fixed on a bracket of the stator assembly 110. The first motor stator 1221 is configured to generate a constant magnetic field and provide an inherent stator magnetic field for the first motor 122. The first motor rotor 1222 is axially connected to the first motor stator 1221 and can rotate relative to the first motor stator 1221. Under electromagnetic interaction, the first motor rotor 1222 drives the rotor assembly 120 rotate, thereby converting the electrical energy into mechanical energy.

The second motor 123 is opposite to the first motor 122 and is located away from the first motor 122 in the stator assembly 110. The second motor 123 is configured to drive the rotor assembly 120 to rotate. The second motor 123 includes a second motor stator 1231 and a second motor rotor 1232. The second motor stator 1231 is arranged on a side close to the rotating shaft 124 and fixed on a bracket of the stator assembly 110. The second motor stator 1231 is configured to generate a constant magnetic field and provide an inherent stator magnetic field for the second motor 123. The second motor rotor 1232 is axially connected to the second motor stator 1231 and can rotate relative to the second motor stator 1231. Under electromagnetic interaction, the second motor rotor 1232 drives the rotor assembly 120 to rotate, thereby converting electrical energy into mechanical energy.

The rotating shaft 124 is located in the stator assembly 110 and extends from the bottom center of the rotor assembly 120 to the stator assembly 110. The rotating shaft 124 rotates under the drive of the first motor 122 and the second motor 123, thereby driving the rotation of the rotor assembly 120. The rotating shaft 124 defines a latching pin hole 1241 adapted to the latching pin 140, which is configured to cooperate with the latching pin 140 to lock or unlock the the rotor assembly 120. The latching pin hole 1241 features a chamfered or filleted outer edge to guide the latching pin during misaligned parking of the rotor assembly 120.

The bearings 125 are symmetrically arranged on two sides of the rotating shaft 124 and are configured to support the rotation of the rotor assembly 120. In this embodiment, a first bearing, a second bearing, a third bearing, and a fourth bearing are respectively arranged on two sides of the rotating shaft 124. The first bearing and the second bearing are located below the first motor 122, and the third bearing and the fourth bearing are located below the second motor 123.

The bistable self-holding electromagnet 130 is installed inside the stator assembly 110 and is located below the second motor 123. After the coil of the bistable self-holding electromagnet 130 is energized, the bistable self-holding electromagnet 130 generates an acting force, which is configured to control an ejection and an retraction of the latching pin 140. Specifically, after the coil of the bistable self-holding electromagnet 130 is energized, the latching pin 140 moves in a first direction and finally stops in the first direction. After the power is cut off, the latching pin 140 still remains in the first position. To return the latching pin 140, a reverse voltage must be applied. The latching pin 140 moves in a second direction and finally stops in a second position after the power is cut off.

The controller is configured to provide a voltage to the bistable self-holding electromagnet 130. Specifically, when the LiDAR 200 is powered off, the controller provides a forward voltage to the bistable self-holding electromagnet 130. When the LiDAR 200 is powered on, the controller provides a reverse voltage to the bistable self-holding electromagnet 130.

The latching pin 140 is located/clamped between the bistable self-holding electromagnet 130 and the bearing 125 and is configured to lock the rotor assembly 120 under the action of the bistable self-holding electromagnet 130. An end of the latching pin 140 has a specific curved surface feature. The curved surface feature enables the latching pin 140 to rebound when the rotor assembly 120 is subjected to a certain rotation torque, avoiding deformation and damage of the rotating shaft 124 and the latching pin 140 due to excessive rotation torque. When the latching pin 140 stops in the first direction or the second direction, if an external force exceeds its holding force, the latching pin 140 can move in the second direction or the first direction.

The LiDAR angle locking mechanism 100 described above locks the rotor assembly 120 by driving the latching pin 140 through the bistable self-holding electromagnet 130. The LiDAR angle locking mechanism 100 in the disclosure has a simple structure and is easy to integrate and miniaturize. The bistable self-holding electromagnet 130 does not require long-term power supply when the LiDAR 200 is operating or turned off. It only needs to be powered on instantly during startup or shutdown, which can reduce power consumption and heat generation. When the rotor assembly 120 is subjected to a large torque, the rotating shaft 124 and the latching pin 140 are not easily damaged. The disclosure effectively improves the working efficiency of the LiDAR 200 and reduces consumption costs.

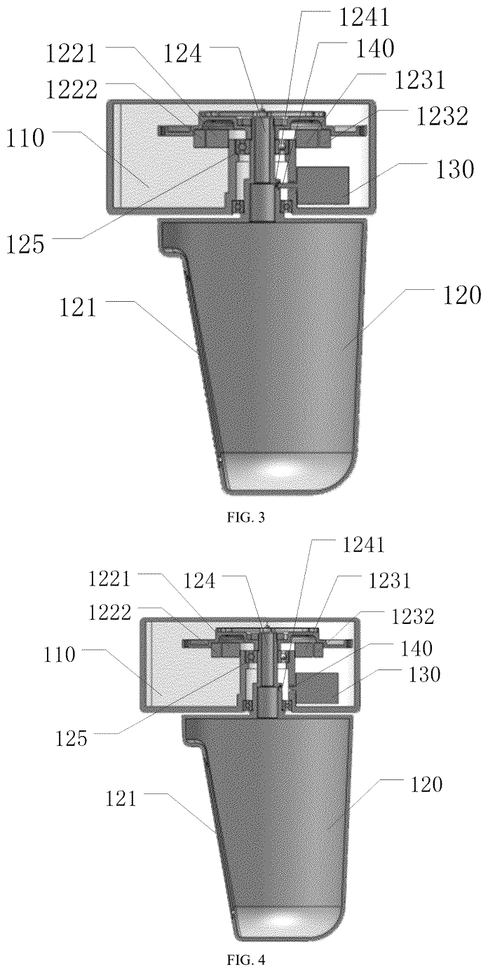

1. Referring to FIG. 3, FIG. 3 is a schematic diagram of a stationary state of a LiDAR in accordance with an embodiment. In this embodiment, when the LiDAR 200 is powered off, the window 121 of the rotor assembly 120 is rotated to face a protected direction based on based on feedback signals from from an angular displacement sensor assembly comprising a code disk and an encoder, until the window arrives at a protected angular position. The rotor assembly 120 provides a forward voltage to the bistable self-holding electromagnet 130 for about 0.3 seconds. After the bistable self-holding electromagnet 130 is energized, the bistable self-holding electromagnet 130 generates an acting force to drive the latching pin 140 to eject. The latching pin 140 moves in the first direction, and the end of the latching pin 140 is inserted into the latching pin hole 1241 which features a chamfer or a fillet. The rotor assembly 120 is locked at a specific angle so that the window 121 is protected from dirt and damage. At this time, the first motor 122 and the second motor 123 stop operating, that is, the first motor rotor 1222 and the second motor rotor 1232 stop rotating. After that, the entire LiDAR 200 is powered off, and the end of the latching pin 140 still remains inserted in the rotor assembly 120, locking the rotor assembly 120.

In some feasible embodiments, if an external force is applied to the latching pin 140 and the external force exceeds its holding force, the latching pin 140 can move from the first direction to the second direction.

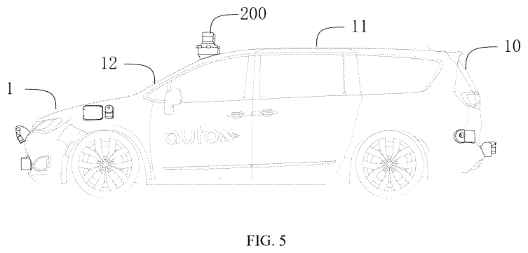

Referring to FIG. 4. FIG. 4 is a schematic diagram of a working state of a LiDAR in accordance with an embodiment. In this embodiment, when the LiDAR 200 is powered on, the LiDAR 200 needs to rotate to achieve detection and scanning. Therefore, the rotor assembly 120 provides a reverse voltage to the bistable self-holding electromagnet 130 for about 0.3 seconds. After the bistable self-holding electromagnet 130 is energized, the bistable self-holding electromagnet 130 generates a reaction force to drive the retraction of the latching pin 140. The latching pin 140 moves in the second direction and maintains, and the rotor assembly 120 is unlocked and the rotational degree of freedom is released. At the same time, the first motor 122 and the second motor 123 start to operate, that is, the first motor rotor 1222 and the second motor rotor 1232 start to rotate. After that, the entire LiDAR 200 is powered on to drive the rotation of the rotor assembly 120.

In some feasible embodiments, if an external force is applied to the latching pin 140 and the external force exceeds its holding force, the latching pin 140 can move from the second direction to the first direction.

The disclosure further provides a LiDAR 200. The LiDAR 200 is a mechanical rotating LiDAR and is applied to autonomous vehicles, unmanned aerial vehicles, robots, etc. The LiDAR 200 can perform 360° horizontal field of view scanning of the surrounding environment. By emitting a laser beam and receiving a returned beam of the emitted beam, the LiDAR 200 can determine the distance and position of an obstacle from a protection target and can provide all-around surrounding environment information for a driverless system. The LiDAR 200 includes a LiDAR transceiver device and the LiDAR angle locking mechanism 100 described above. The LiDAR angle locking mechanism 100 is applied to the LiDAR 200 to lock the rotor assembly 120 when the LiDAR 200 is in a stopped operating state, so that the window 121 is locked in a protected direction. For the specific structure of the LiDAR angle locking mechanism 100, please refer to the above description, which will not be repeated here.

The LiDAR transceiver device is arranged in the rotor assembly 120 and provided with a transmitter and a receiver. The transmitter is configured to emit a laser beam, and the receiver is configured to receive a returned echo beam of the emitted beam. The LiDAR transceiver device starts to operate when the LiDAR is in an operating state, emits a laser beam for detection and scanning, and follows the rotation of the rotor assembly 120.

Referring to FIG. 5 in combination. FIG. 5 is a schematic diagram of a vehicle in accordance with an embodiment. The disclosure further provides a vehicle 1. The vehicle 1 includes a vehicle roof 11 and the LiDAR 200 described above. The LiDAR 200 can be mounted on the vehicle roof 11.

In some feasible embodiments, the LiDAR 200 can also be mounted on the vehicle body and the side of the vehicle body of the vehicle 1. Specifically, the LiDAR 200 can be mounted on the front and rear bumpers, the vehicle roof, the headlights, the front hood, and other sides of the vehicle.

The LiDAR angle locking mechanism 100, the LiDAR 200, and the vehicle 1 described above utilize a braking scheme of driving the latching pin 140 through the bistable self-holding electromagnet 130 to lock the window 121 in the rotor assembly 120 to a side facing a protected side when the LiDAR 200 is powered off. This avoids dirt, damage, and detection of the LiDAR window 121. The locking scheme of the disclosure has a simple structure, is easy to integrate and miniaturize, and does not require long-term power supply when the LiDAR 200 is operating or turned off. It only needs to be powered on instantly during startup or shutdown, which can save power.

Obviously, those skilled in the art can make various modifications and variations to the disclosure without departing from the spirit and scope of the disclosure. Therefore, if these modifications and variations of the disclosure fall within the scope of the claims of the disclosure and their equivalent technologies, the disclosure also intends to include these modifications and variations.

It should be understood that although the steps in the flowchart of the drawings are displayed in sequence as indicated by arrows, these steps are not necessarily executed in the sequence indicated by the arrows. Unless explicitly stated in the disclosure, the execution of these steps is not strictly limited in sequence, and they may be executed in other sequences. Moreover, at least a part of the steps in the flowchart of the drawings may include a plurality of sub-steps or a plurality of stages. These sub-steps or stages are not necessarily executed and completed at the same time, but may be executed at different times. The execution sequence thereof is not necessarily sequential, but may be alternately executed with other steps or at least a part of the sub-steps or stages of other steps.

The above-enumerated are merely preferred embodiments of the disclosure, and of course, they cannot be configured to limit the scope of the claims of the disclosure. Therefore, equivalent changes made in accordance with the claims of the disclosure are still within the scope encompassed by the disclosure.

1. A LiDAR angle locking mechanism, comprising:
a stator assembly;
a rotor assembly, coupled to the stator assembly by a rotating shaft, the rotor assembly including a window; and
a motor, configured to drive the rotor assembly rotate with respective with the stator assembly around the rotating shaft;
a bistable self-holding electromagnet;
a controller, and
a latching pin, arranged between the rotating shaft and the bistable self-holding electromagnet;
wherein:
when the LiDAR is powered off, the rotor assembly rotates to make the window face to a predetermined protected side; the controller provides a forward voltage to the bistable self-holding electromagnet so that the latching pin ejects and inserts into the rotor assembly to lock the rotor assembly, and the motor stops operating;
when the LiDAR is powered on, the controller provides a reverse voltage to the bistable self-holding electromagnet so that the latching pin retracts and withdraws from the rotor assembly to unlock the rotor assembly; after the rotor assembly is unlocked, the motor starts to operate and drives the rotation of the rotor assembly.

2. The LiDAR angle locking mechanism according to claim 1, wherein when the LiDAR is powered off, the rotor assembly is rotated based on feedback signals from from an angular displacement sensor assembly comprising a code disk and an encoder, until the window arrives at a protected angular position.

3. The LiDAR angle locking mechanism according to claim 1, wherein the motor includes a first motor and a second motor, and the first motor and the second motor are symmetrically arranged on two sides of the rotating shaft.

4. The LiDAR angle locking mechanism according to claim 3, wherein the first motor includes a first motor stator and a first motor rotor, the first motor stator and the first motor rotor are axially connected, and the first motor stator is arranged at an end close to the rotating shaft.

5. The LiDAR angle locking mechanism according to claim 3, wherein the second motor includes a second motor stator and a second motor rotor, the second motor stator and the second motor rotor are axially connected, and the second motor stator is arranged at an end close to the rotating shaft.

6. The LiDAR angle locking mechanism according to claim 1, wherein the rotating shaft defines a latching pin hole adapted to the latching pin, and cooperates with the latching pin to enable the rotor assembly to be locked or unlocked.

7. The LiDAR angle locking mechanism according to claim 1, wherein a bearing is arranged beside the rotating shaft.

8. The LiDAR angle locking mechanism according to claim 1, wherein a chamfer or a fillet disposed on an outer periphery of the latching pin hole for guiding, and the edge of the latching pin hole and the latching pin have curved surfaces.

9. A LiDAR, comprising:
a LiDAR transceiver device; and
a LiDAR angle locking mechanism, comprising:
a stator assembly;
a rotor assembly, coupled to the stator assembly by a rotating shaft, the rotor assembly including a window; and
a motor, configured to drive the rotor assembly rotate with respective with the stator assembly around the rotating shaft;
a bistable self-holding electromagnet;
a controller, and
a latching pin, arranged between the rotating shaft and the bistable self-holding electromagnet;
wherein:
when the LiDAR is powered off, the rotor assembly rotates to make the window face to a predetermined protected side; the controller provides a forward voltage to the bistable self-holding electromagnet so that the latching pin ejects and inserts into the rotor assembly to lock the rotor assembly, and the motor stops operating;
when the LiDAR is powered on, the controller provides a reverse voltage to the bistable self-holding electromagnet so that the latching pin retracts and withdraws from the rotor assembly to unlock the rotor assembly; after the rotor assembly is unlocked, the motor starts to operate and drives the rotation of the rotor assembly.

10. The LiDAR according to claim 9, wherein when the LiDAR is powered off, the rotor assembly is rotated based on feedback signals from from an angular displacement sensor assembly comprising a code disk and an encoder, until the window arrives at a protected angular position.

11. The LiDAR according to claim 9, wherein the motor includes a first motor and a second motor, and the first motor and the second motor are symmetrically arranged on two sides of the rotating shaft.

12. The LiDAR according to claim 11, wherein the first motor includes a first motor stator and a first motor rotor, the first motor stator and the first motor rotor are axially connected, and the first motor stator is arranged at an end close to the rotating shaft.

13. The LiDAR according to claim 11, wherein the second motor includes a second motor stator and a second motor rotor, the second motor stator and the second motor rotor are axially connected, and the second motor stator is arranged at an end close to the rotating shaft.

14. The LiDAR according to claim 9, wherein the rotating shaft defines a latching pin hole adapted to the latching pin, and cooperates with the latching pin to enable the rotor assembly to be locked or unlocked.

15. The LiDAR according to claim 9, wherein a bearing is arranged beside the rotating shaft.

16. The LiDAR according to claim 9, wherein a chamfer or a fillet disposed on an outer periphery of the latching pin hole for guiding, and the edge of the latching pin hole and the latching pin have curved surfaces.

17. A vehicle, comprising:
a vehicle roof; and
a LiDAR arranged on the vehicle roof, the LiDAR comprising:
a LiDAR transceiver device; and
a LiDAR angle locking mechanism, comprising:
a stator assembly;
a rotor assembly, coupled to the stator assembly by a rotating shaft, the rotor assembly including a window; and
a motor, configured to drive the rotor assembly rotate with respective with the stator assembly around the rotating shaft;
a bistable self-holding electromagnet;
a controller, and
a latching pin, arranged between the rotating shaft and the bistable self-holding electromagnet;
wherein:
when the LiDAR is powered off, the rotor assembly rotates to make the window face to a predetermined protected side; the controller provides a forward voltage to the bistable self-holding electromagnet so that the latching pin ejects and inserts into the rotor assembly to lock the rotor assembly, and the motor stops operating;
when the LiDAR is powered on, the controller provides a reverse voltage to the bistable self-holding electromagnet so that the latching pin retracts and withdraws from the rotor assembly to unlock the rotor assembly; after the rotor assembly is unlocked, the motor starts to operate and drives the rotation of the rotor assembly.

18. The LiDAR according to claim 17, wherein the rotating shaft defines a latching pin hole adapted to the latching pin, and cooperates with the latching pin to enable the rotor assembly to be locked or unlocked.

19. The LiDAR according to claim 17, wherein a bearing is arranged beside the rotating shaft.

20. The LiDAR according to claim 17, wherein a chamfer or a fillet disposed on an outer periphery of the latching pin hole for guiding, and the edge of the latching pin hole and the latching pin have curved surfaces.
